(19) United States
(12) Patent Application Publication
(10) Pub. No.: US 2017/0069417 A1
(43) Pub. Date: Mar. 9, 2017

(54) ELECTRONIC COMPONENT

(71) Applicant: MURATA MANUFACTURING CO., LTD., Kyoto-fu (JP)

(72) Inventor: Yasushi TAKEDA, Nagaokakyo-shi (JP)

(73) Assignee: MURATA MANUFACTURING CO., LTD., Kyoto-fu (JP)

(21) Appl. No.: 15/248,666

(22) Filed: Aug. 26, 2016

(30) Foreign Application Priority Data
Sep. 4, 2015 (JP) 2015-174679

(51) Int. Cl. H01F 27/28

(52) U.S. Cl. CPC H01F 27/2804; H01F 2027/2809

(57) ABSTRACT

An electronic component including, a first side, a second side, a third side, and a fourth side connected in that order in a predetermined direction so as to demarcate a tetragonal track. A first coil conductor layer lies astride the first side and the second side. A second coil conductor layer lies astride the second side and the third side and is connected to the first coil conductor layer on the second side. A third coil conductor layer lies astride the third side and the fourth side and is connected to the second coil conductor layer on the third side. At least one of the first coil conductor layer and the third coil conductor layer is not disposed at a first corner formed by the first side and the fourth side, when viewed from the stacking direction.

### CROSS REFERENCE TO RELATED APPLICATIONS

This application claims benefit of priority to Japanese Patent Application 2015-174679 filed Sep. 4, 2015, the entire content of which is incorporated herein by reference.

### TECHNICAL FIELD

The present disclosure relates to an electronic component including a coil.

### BACKGROUND

To date, a multilayer electronic component described in, for example, Japanese Unexamined Patent Application Publication No. 2010-183007 is known as an electronic component. FIG. 20 is an exploded perspective view of a multilayer body 100 of the multilayer electronic component described in Japanese Unexamined Patent Application Publication No. 2010-183007.

As shown in FIG. 20, the multilayer electronic component includes a multilayer body 100 and inner conductor layers 102a to 102d. In this regard, inner conductor layers other than the inner conductor layers 102a to 102d are included in the multilayer body 100. However, only the inner conductor layers necessary for explanation are provided with reference numerals. The multilayer body 100 has a configuration in which multilayer body sheets 104a to 104l are stacked in that order from top to bottom.

The inner conductor layers 102a to 102d are disposed in the multilayer body sheets 104d to 104g, respectively, and have the shape of substantially the letter L. Specifically, the inner conductor layers 102a to 102d overlap each other so as to form a substantially rectangular track, when viewed from above. The inner conductor layer 102a overlaps with a right short side and a rear long side of the track. The inner conductor layer 102b overlaps a rear long side and a left short side of the track. The inner conductor layer 102c overlaps a left short side and a front long side of the track. The inner conductor layer 102d overlaps a front long side and a right short side of the track. The inner conductor layers 102a to 102d penetrate the multilayer body sheets 104d to 104g, respectively, in the vertical direction. Therefore, the inner conductor layer 102a is connected to the inner conductor layer 102b on the rear long side. The inner conductor layer 102b is connected to the inner conductor layer 102c on the left short side. The inner conductor layer 102c is connected to the inner conductor layer 102d on the front long side. Consequently, a spiral coil is formed.

The multilayer electronic component described in Japanese Unexamined Patent Application Publication No. 2010-183007 has a problem that short-circuit of the coil occurs easily. Specifically, for example, the right short side of the inner conductor layer 102a is opposite to the right short side of the inner conductor layer 102d. However, there are two insulator layers 104e and 104f between the two short sides. Consequently, the probability of occurrence of short-circuit between the right short side of the inner conductor layer 102a and the right short side of the inner conductor layer 102d is relatively low.

On the other hand, the end portion on the upstream side in the counterclockwise direction of the inner conductor layer 102a is opposite to the end portion on the downstream side in the counterclockwise direction of the inner conductor layer 102c. There is only one insulator layer 104e between these two end portions. Consequently, the probability of occurrence of short-circuit between the end portion on the upstream side in the counterclockwise direction of the inner conductor layer 102a and the end portion on the downstream side in the counterclockwise direction of the inner conductor layer 102c is relatively high. Therefore, the multilayer electronic component described in Japanese Unexamined Patent Application Publication No. 2010-183007 has a possibility of occurrence of short-circuit in the coil at specific locations.

### SUMMARY

Accordingly, it is an object of the present disclosure to provide an electronic component, in which an occurrence of short circuit in a coil can be suppressed.

According to preferred embodiments of the present disclosure, an electronic component includes a multilayer body having a configuration, in which a plurality of insulator layers are stacked in the stacking direction, and a coil, which is disposed in the multilayer body and which includes a first coil conductor layer, a second coil conductor layer, and a third coil conductor layer arranged in that order from one side of the stacking direction toward the other side, wherein a first side, a second side, a third side, and a fourth side are connected in that order in a predetermined direction so as to demarcate a tetragonal track, when viewed from the stacking direction, the first coil conductor layer lies astride the first side and the second side, the second coil conductor layer lies astride the second side and the third side and is connected to the first coil conductor layer on the second side, the third coil conductor layer lies astride the third side and the fourth side and is connected to the second coil conductor layer on the third side, and at least one of the first coil conductor layer and the third coil conductor layer is not disposed at a first corner formed by the first side and the fourth side, when viewed from the stacking direction.

According to preferred embodiments of the present disclosure, an electronic component includes a multilayer body having a configuration, in which a plurality of insulator layers are stacked in the stacking direction, and a coil, which is disposed in the multilayer body and which includes a first coil conductor layer, a second coil conductor layer, a third coil conductor layer, and a fourth coil conductor layer arranged in that order from one side of the stacking direction toward the other side, wherein a first side, a second side, a third side, and a fourth side are connected in that order in a predetermined direction so as to demarcate a tetragonal track, when viewed from the stacking direction, the first coil conductor layer and the second coil conductor layer lie astride the first side and the second side and are connected to each other on the first side and the second side, the third coil conductor layer lies astride the second side and the third side and is connected to the second coil conductor layer on the second side, the fourth coil conductor layer lies astride the third side and the fourth side and is connected to the third coil conductor layer on the third side, and at least one of the second coil conductor layer and the fourth coil conductor layer is not disposed at a first corner formed by the first side and the fourth side, when viewed from the stacking direction.

Other features, elements, characteristics and advantages of the present disclosure will become more apparent from the following detailed description of preferred embodiments of the present disclosure with reference to the attached drawings.

### BRIEF DESCRIPTION OF THE DRAWINGS

FIG. 1 is an outside perspective view of each of electronic components.

FIG. 2 is an exploded perspective view of a multilayer body of the electronic component.

FIG. 3A is a diagram of a track, viewed from above.

FIG. 3B is a diagram of part of a track according to another example, viewed from above.

FIG. 4A is a diagram showing the positional relationship between coil conductor layers in the electronic component.

FIG. 4B is a structural sectional view of the electronic component, along a line 4-4 shown in FIG. 1.

FIG. 5 is a diagram showing the manner at the time of production of the electronic component in plan view.

FIG. 6 is a diagram showing the manner at the time of production of the electronic component in plan view.

FIG. 7 is a diagram showing the manner at the time of production of the electronic component in plan view.

FIG. 8 is a diagram showing the manner at the time of production of the electronic component in plan view.

FIG. 9 is a diagram showing the manner at the time of production of the electronic component in plan view.

FIG. 10 is a diagram showing the manner at the time of production of the electronic component in plan view.

FIG. 11A is a diagram showing the manner at the time of production of the electronic component in plan view.

FIG. 11B is a diagram showing the positional relationship between coil conductor layers in an electronic component according to a comparative example.

FIG. 12 is an exploded perspective view of a multilayer body of an electronic component according to a first modified example.

FIG. 13 is a diagram showing the positional relationship between coil conductor layers in the electronic component according to the first modified example.

FIG. 14 is a diagram showing the positional relationship between coil conductor layers in an electronic component according to a second modified example.

FIG. 15 is a diagram showing the positional relationship between coil conductor layers in an electronic component according to a third modified example.

FIG. 16 is a diagram showing the positional relationship between coil conductor layers in an electronic component according to a fourth modified example.

FIG. 17 is a diagram showing the positional relationship between coil conductor layers in an electronic component according to a fifth modified example.

FIG. 18 is an exploded perspective view of a multilayer body of an electronic component according to a sixth modified example.

FIG. 19 is a diagram showing the positional relationship between coil conductor layers in the electronic component according to the sixth modified example. and

FIG. 20 is an exploded perspective view of a multilayer body of a multilayer electronic component described in Japanese Unexamined Patent Application Publication No. 2010-183007.

### DETAILED DESCRIPTION OF THE DRAWINGS

Configuration of Electronic Component

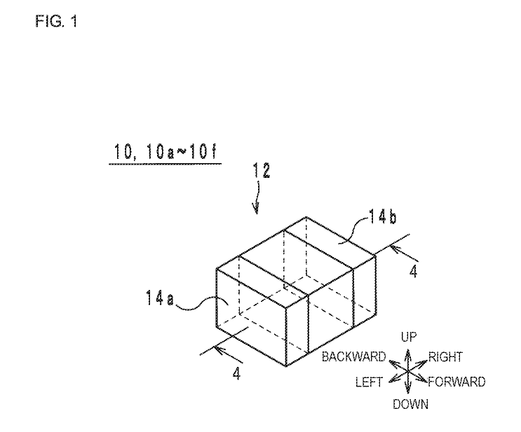

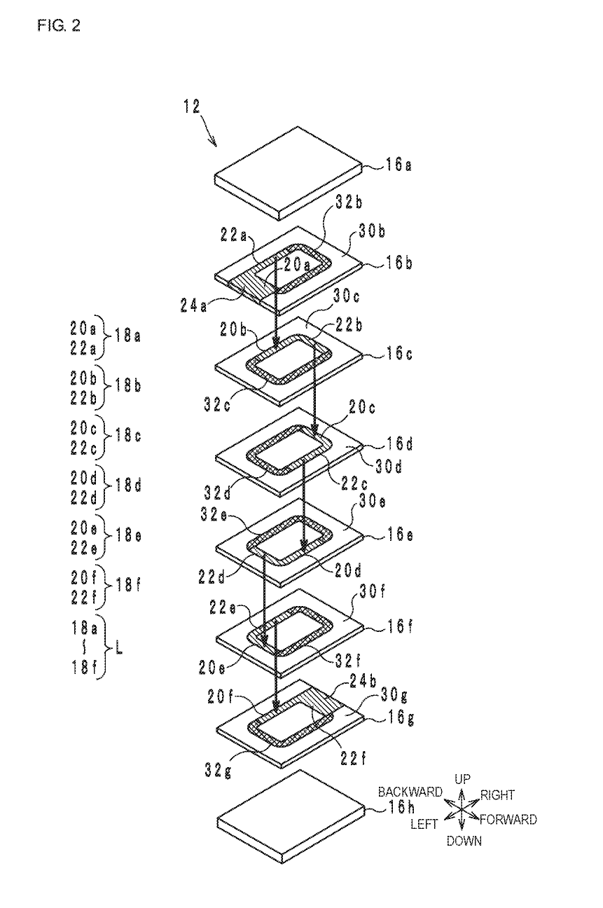

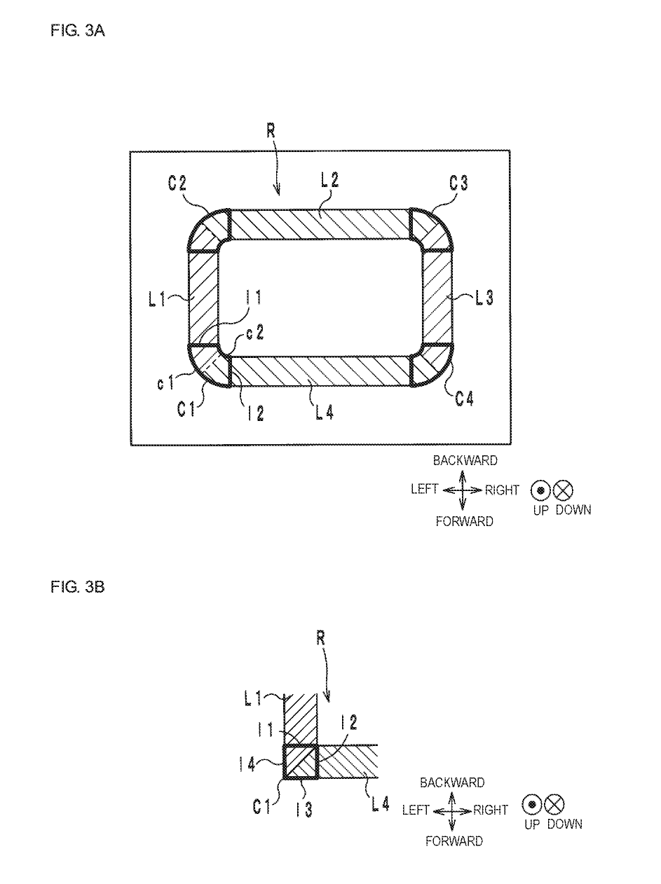

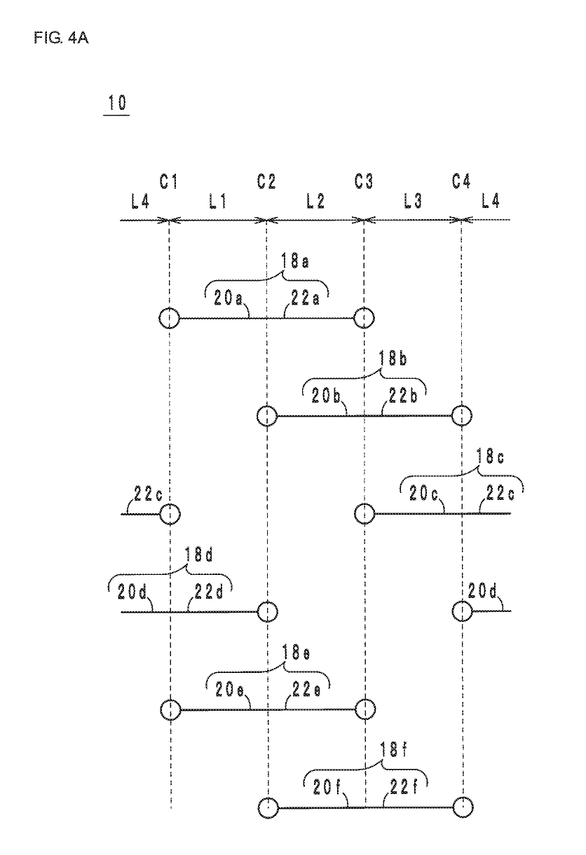

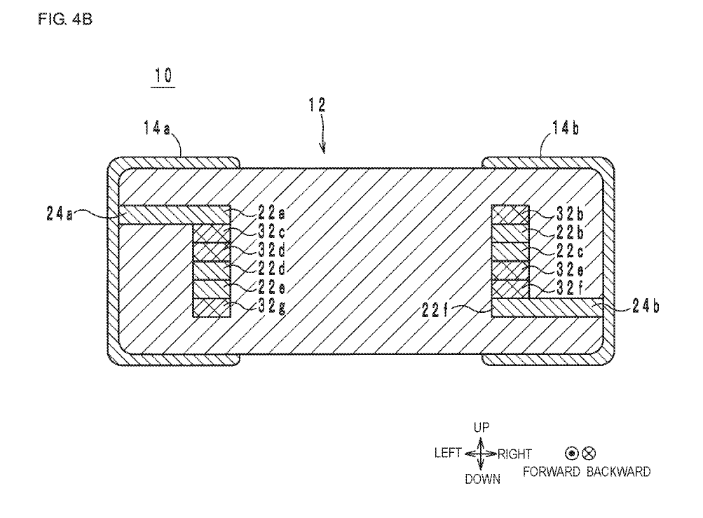

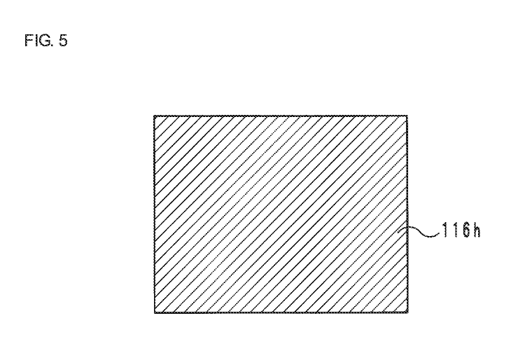

The configuration of an electronic component according to an embodiment of the present disclosure will be described below with reference to the drawings. FIG. 1 is an outside perspective view of each of electronic components 10 and 10a to 10f. FIG. 2 is an exploded perspective view of a multilayer body 12 of the electronic component 10. FIG. 3A is a diagram of a track R, viewed from above. FIG. 3B is a diagram of part of a track R according to another example, viewed from above. FIG. 4A is a diagram showing the positional relationship between coil conductor layers 18a to 18f in the electronic component 10. FIG. 4B is a structural sectional view of the electronic component 10a, along a line 4-4 shown in FIG. 1.

Hereafter the stacking direction of the electronic component 10 is defined as the vertical direction (the upper side is an example of one side of the stacking direction and the lower side is an example of the other side of the stacking direction). When the electronic component 10 is viewed from above, the direction of extension of the long side of the electronic component 10 is defined as the lateral direction, and the direction of extension of the short side of the electronic component 10 is defined as the forward or backward direction. The vertical direction, the forward or backward direction, and the lateral direction are orthogonal to each other.

As shown in FIG. 1 and FIG. 2, the electronic component includes the multilayer body 12, outer electrodes 14a and 14b, lead conductor layers 24a and 24b, and a coil L. As shown in FIG. 2, the multilayer body 12 has a substantially rectangular parallelepiped shape and has a configuration in which insulator layers 16a to 16h are stacked so as to be arranged in that order from top to bottom.

The insulator layers 16a to 16h are produced from ferrite having magnetism (for example, Ni—Zn—Cu ferrite, Ni—Zn ferrite, or the like) and are substantially rectangular insulator layers, when viewed from above. The insulator layers 16b to 16g include magnetic portions 30b to 30g, respectively, and nonmagnetic portions 32b to 32g, respectively. The magnetic portions 30b to 30g are produced from ferrite having magnetism (for example, Ni—Zn—Cu ferrite, Ni—Zn ferrite, or the like). The nonmagnetic portions 32b to 32g are produced from nonmagnetic (that is, the magnetic permeability is 1) ferrite (for example, Zn—Cu ferrite). However, instead of the nonmagnetic portions 32b to 32g, low-magnetic portions having a magnetic permeability lower than the magnetic permeability of the magnetic portions 30b to 30g may be used. The track R will be described with reference to FIG. 3A and FIG. 3B before the shapes of the magnetic portions 30b to 30g and the nonmagnetic portions 32b to 32g are described.

In the electronic component 10, the track R is defined as shown in FIG. 3A. The track R has a substantially tetragonal (rectangular in the present embodiment) frame shape and is composed of sides L1 (an example of a first side), L2 (an example of a second side), L3 (an example of a third side), and L4 (an example of a fourth side), which are connected in that order in the counterclockwise direction (an example of a predetermined direction). The corners of the track R are chamfered. The sides L1 and L3 are short sides extending in the forward or backward direction and the sides L2 and L4 are long sides extending in the lateral direction.

The corner formed by the side L1 and the side L4 is defined as a corner C1 (an example of a first corner). The corner formed by the side L1 and the side L2 is defined as a corner C2 (an example of a second corner). The corner formed by the side L2 and the side L3 is defined as a corner C3 (an example of a third corner). The corner formed by the side L3 and the side L4 is defined as a corner C4 (an example of a fourth corner).

The borders between the sides L1 to L4 and the corners C1 to C4 will be described. The corners C1 to C4 of the track R are chamfered. The corner C1 is a region surrounded by a thick line shown in FIG. 3A and is, specifically, a region surrounded by an arc portion c1 in an outer edge portion of the track R, an arc portion c2 in an inner edge portion of the track R, a straight line portion l1 connecting one end of the arc portion c1 to one end of the arc portion c2, and a straight line portion l2 connecting the other end of the arc portion c1 to the other end of the arc portion c2. In this regard, the corners C2 to C4 are the same as the corner C1 and, therefore, explanations thereof will not be provided.

In the case where the corners C1 to C4 of the track R are not chamfered, as shown in FIG. 3B, the corner C1 is a region surrounded by straight line portions l1 to l4. The straight line portion l1 is a straight line extending from the inner corner of the track R toward the left side. The straight line portion l2 is a straight line extending from the inner corner of the track R forward. The straight line portion l3 is a straight line extending from the outer corner of the track R toward the right side. The straight line portion l4 is a straight line extending from the outer corner of the track R backward.

The left rear half of the corner C1 is a front end of the side L1, and the left front half of the corner C2 is the rear end of the side L1. The right rear half of the corner C2 is a left end of the side L2, and the left rear half of the corner C3 is the right end of the side L2. The right front half of the corner C3 is a rear end of the side L3, and the right rear half of the corner C4 is the front end of the side L3. The left front half of the corner C4 is a right end of the side L4, and the right front half of the corner C1 is the left end of the side L4.

The shapes of the magnetic portions 30b to 30g and the nonmagnetic portions 32b to 32g will be described. As shown in FIG. 2 and FIG. 3A, the nonmagnetic portion 32b is disposed in the vicinity of the right end of the side L2, the side L3, the side L4, and the left rear half of the corner C1 (that is, the front end of the side L1). The vicinity of the right end of the side L2 refers to the right end of the side L2 (that is, the left rear half of the corner C3) and a portion adjacent to the right end, in the side L2. As shown in FIG. 2 and FIG. 3A, the nonmagnetic portion 32c is disposed in the right rear half of the corner C4, the side L4, the side L1, and the vicinity of the left end of the side L2. As shown in FIG. 2 and FIG. 3A, the nonmagnetic portion 32d is disposed in the vicinity of the left end of the side L4, the side L1, the side L2, and the right front half of the corner C3 (that is, the rear end of the side L3). As shown in FIG. 2 and FIG. 3A, the nonmagnetic portion 32e is disposed in the left front half of the corner C2, the side L2, the side L3, and the vicinity of the right end of the side L4. As shown in FIG. 2 and FIG. 3A, the nonmagnetic portion 32f is disposed in the vicinity of the right end of the side L2, the side L3, the side L4, and the left rear half of the corner C1 (that is, the front end of the side L1). As shown in FIG. 2 and FIG. 3A, the nonmagnetic portion 32g is disposed in the right rear half of the corner C4 (that is, the front end of the side L3), the side L4, the side L1, and the vicinity of the left end of the side L2.

The magnetic portions 30c to 30f are portions other than the track R in the insulator layers 16c to 16f. The magnetic portion 30b is a portion other than the track R and the lead conductor layer 24a, described later, in the insulator layer 16b. The magnetic portion 30g is a portion other than the track R and the lead conductor layer 24b, described later, in the insulator layer 16g.

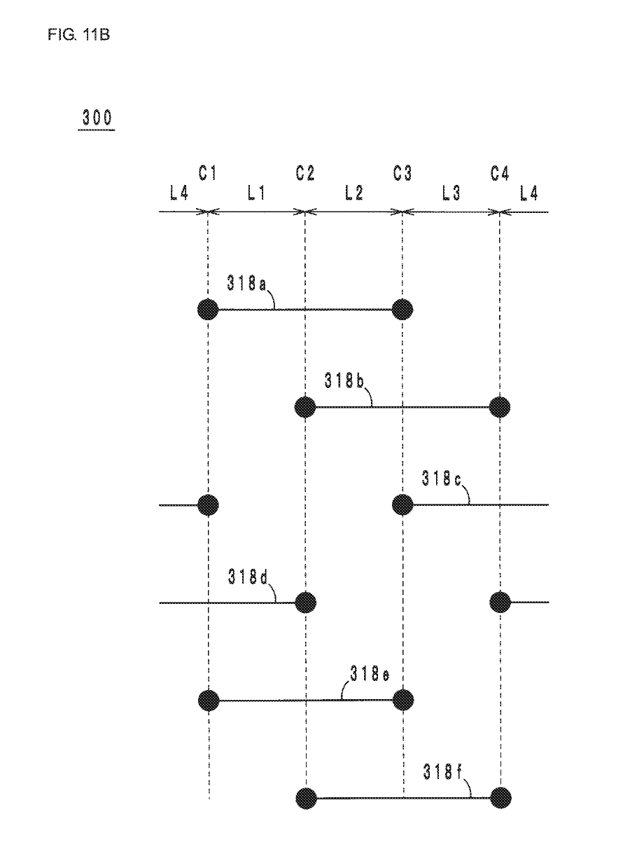

As shown in FIG. 2, the coil L includes coil conductor layers 18a to 18f, and has a spiral shape spiraling downward in the clockwise direction, when viewed from above. The coil conductor layers 18a to 18f are disposed in the multilayer body 12 and are arranged in that order from top to bottom. The coil conductor layers 18a to 18f overlap one another so as to form the track R, when viewed from above. The coil conductor layers 18a to 18f will be described below in detail with reference to FIG. 2 and FIG. 4A. In FIG. 4A, both ends of each of the coil conductor layers 18a to 18f are expressed as open circles so as to indicate that the coil conductor layers 18a to 18f are not disposed at the respective corners C1 to C4 expressed as open circles. In this regard, in FIG. 11B and the like described later, both ends of each of the coil conductor layers 18a to 18f are expressed as solid circles so as to indicate that the coil conductor layers 18a to 18f are disposed at the respective corners C1 to C4 expressed as solid circles.

As shown in FIG. 2 and FIG. 4A, the coil conductor layer 18a (an example of a first coil conductor layer) lies astride the sides L1 and L2 and has the shape of substantially the letter L, when viewed from above. The coil conductor layer 18a is disposed in the insulator layer 16b so as to penetrate the insulator layer 16b in the vertical direction. That is, the thickness of the coil conductor layer 18a is substantially equal to the thickness of the insulator layer 16b. Consequently, the coil conductor layer 18a having the shape of substantially the letter L is exposed when the insulator layer 16b is viewed from above and when the insulator layer 16b is viewed from below.

The coil conductor layer 18a is disposed in a portion excluding the corner C1 of the side L1 and a portion excluding the vicinity of the right end of the side L2. Therefore, as shown in FIG. 2 and FIG. 4A, the coil conductor layer 18a is not disposed at the corners C1 and C3. Hereafter in the coil conductor layer 18a, a portion overlapping the side L1 is referred to as a portion 20a and in the coil conductor layer 18a, a portion overlapping the side L2 is referred to as a portion 22a. As shown in FIG. 2, the portion 22a (that is, the coil conductor layer 18a) is disposed in the portion excluding the vicinity of the right end of the side L2 and, therefore, is not in contact with the corner C3. That is, the nonmagnetic portion 32b is present between the right end of the portion 22a and the corner C3. The coil conductor layer 18a constitutes the track R by being combined with the nonmagnetic portion 32b, when viewed from above.

As shown in FIG. 2 and FIG. 4A, the coil conductor layer 18b (an example of a second coil conductor layer) lies astride the sides L2 and L3 and has the shape of substantially the letter L, when viewed from above. The coil conductor layer 18b is disposed in the insulator layer 16c so as to penetrate the insulator layer 16c in the vertical direction. That is, the thickness of the coil conductor layer 18b is substantially equal to the thickness of the insulator layer 16c. Consequently, the coil conductor layer 18b having the shape of substantially the letter L is exposed when the insulator layer 16c is viewed from above and when the insulator layer 16c is viewed from below.

The coil conductor layer 18b is disposed in a portion excluding the vicinity of the left end of the side L2 and a portion excluding the corner C4 of the side L3. Therefore, as shown in FIG. 2 and FIG. 4A, the coil conductor layer 18b is not disposed at the corners C2 and C4. Hereafter in the coil conductor layer 18b, a portion overlapping the side L2 is referred to as a portion 20b and in the coil conductor layer 18b, a portion overlapping the side L3 is referred to as a portion 22b. As shown in FIG. 2, the portion 20b (that is, the coil conductor layer 18b) is disposed in the portion excluding the vicinity of the left end of the side L2 and, therefore, is not in contact with the corner C2. That is, the nonmagnetic portion 32c is present between the left end of the portion 20b and the corner C2. The coil conductor layer 18b constitutes the track R by being combined with the nonmagnetic portion 32c, when viewed from above. The portion 20b of the coil conductor layer 18b is connected to the portion 22a (coil conductor layer 18a).

As shown in FIG. 2 and FIG. 4A, the coil conductor layer 18c (an example of a third coil conductor layer) lies astride the sides L3 and L4 and has the shape of substantially the letter L, when viewed from above. The coil conductor layer 18c is disposed in the insulator layer 16d so as to penetrate the insulator layer 16d in the vertical direction. That is, the thickness of the coil conductor layer 18c is substantially equal to the thickness of the insulator layer 16d. Consequently, the coil conductor layer 18c having the shape of substantially the letter L is exposed when the insulator layer 16d is viewed from above and when the insulator layer 16d is viewed from below.

The coil conductor layer 18c is disposed in a portion excluding the corner C3 of the side L3 and a portion excluding the vicinity of the left end of the side L4. Therefore, as shown in FIG. 2 and FIG. 4A, the coil conductor layer 18c is not disposed at the corners C1 and C3. Hereafter in the coil conductor layer 18c, a portion overlapping the side L3 is referred to as a portion 20c and in the coil conductor layer 18c, a portion overlapping the side L4 is referred to as a portion 22c. As shown in FIG. 2, the portion 22c (that is, the coil conductor layer 18c) is disposed in the portion excluding the vicinity of the left end of the side L4 and, therefore, is not in contact with the corner C1. That is, the nonmagnetic portion 32d is present between the left end of the portion 22c and the corner C1. The coil conductor layer 18c constitutes the track R by being combined with the nonmagnetic portion 32d, when viewed from above. The portion 20c of the coil conductor layer 18c is connected to the portion 22b (coil conductor layer 18b).

As shown in FIG. 2 and FIG. 4A, the coil conductor layer 18d (an example of a fourth coil conductor layer) lies astride the sides L4 and L1 and has the shape of substantially the letter L, when viewed from above. The coil conductor layer 18d is disposed in the insulator layer 16e so as to penetrate the insulator layer 16e in the vertical direction. That is, the thickness of the coil conductor layer 18d is substantially equal to the thickness of the insulator layer 16e. Consequently, the coil conductor layer 18d having the shape of substantially the letter L is exposed when the insulator layer 16e is viewed from above and when the insulator layer 16e is viewed from below.

The coil conductor layer 18d is disposed in a portion excluding the vicinity of the right end of the side L4 and a portion excluding the corner C2 of the side L1. Therefore, as shown in FIG. 2 and FIG. 4A, the coil conductor layer 18d is not disposed at the corners C2 and C4. Hereafter in the coil conductor layer 18d, a portion overlapping the side L4 is referred to as a portion 20d and in the coil conductor layer 18d, a portion overlapping the side L1 is referred to as a portion 22d. As shown in FIG. 2, the portion 20d (that is, the coil conductor layer 18d) is disposed in the portion excluding the vicinity of the right end of the side L4 and, therefore, is not in contact with the corner C4. That is, the nonmagnetic portion 32e is present between the right end of the portion 20d and the corner C4. The coil conductor layer 18d constitutes the track R by being combined with the nonmagnetic portion 32e, when viewed from above. The portion 20d of the coil conductor layer 18d is connected to the portion 22c (coil conductor layer 18c).

As shown in FIG. 2 and FIG. 4A, the coil conductor layer 18e (an example of a fifth coil conductor layer) lies astride the sides L1 and L2 and has the shape of substantially the letter L, when viewed from above. The coil conductor layer 18e is disposed in the insulator layer 16f so as to penetrate the insulator layer 16f in the vertical direction. That is, the thickness of the coil conductor layer 18e is substantially equal to the thickness of the insulator layer 16f. Consequently, the coil conductor layer 18e having the shape of substantially the letter L is exposed when the insulator layer 16f is viewed from above and when the insulator layer 16f is viewed from below.

The coil conductor layer 18e is disposed in a portion excluding the corner C1 of the side L1 and a portion excluding the vicinity of the right end of the side L2. Therefore, as shown in FIG. 2 and FIG. 4A, the coil conductor layer 18e is not disposed at the corners C1 and C3. Hereafter in the coil conductor layer 18e, a portion overlapping the side L1 is referred to as a portion 20e and in the coil conductor layer 18e, a portion overlapping the side L2 is referred to as a portion 22e. As shown in FIG. 2, the portion 22e (that is, the coil conductor layer 18e) is disposed in the portion excluding the vicinity of the right end of the side L2 and, therefore, is not in contact with the corner C3. That is, the nonmagnetic portion 32f is present between the right end of the portion 22e and the corner C3. The coil conductor layer 18e constitutes the track R by being combined with the nonmagnetic portion 32f, when viewed from above. The portion 20e of the coil conductor layer 18e is connected to the portion 22d (coil conductor layer 18d).

As shown in FIG. 2 and FIG. 4A, the coil conductor layer 18f (an example of a sixth coil conductor layer) lies astride the side L2 and L3 and has the shape of substantially the letter L, when viewed from above. The coil conductor layer 18f is disposed in the insulator layer 16g so as to penetrate the insulator layer 16g in the vertical direction. That is, the thickness of the coil conductor layer 18f is substantially equal to the thickness of the insulator layer 16g. Consequently, the coil conductor layer 18f having the shape of substantially the letter L is exposed when the insulator layer 16g is viewed from above and when the insulator layer 16g is viewed from below.

The coil conductor layer 18f is disposed in a portion excluding the vicinity of the left end of the side L2 and a portion excluding the corner C4 of the side L3. Therefore, as shown in FIG. 2 and FIG. 4A, the coil conductor layer 18f is not disposed at the corners C2 and C4. Hereafter in the coil conductor layer 18f, a portion overlapping the side L2 is referred to as a portion 20f and in the coil conductor layer 18f, a portion overlapping the side L3 is referred to as a portion 22f. As shown in FIG. 2, the portion 20f (that is, the coil conductor layer 18f) is disposed in the portion excluding the vicinity of the left end of the side L2 and, therefore, is not in contact with the corner C2. That is, the nonmagnetic portion 32g is present between the left end of the portion 20f and the corner C2. The coil conductor layer 18f constitutes the track R by being combined with the nonmagnetic portion 32g, when viewed from above. The portion 20f of the coil conductor layer 18f is connected to the portion 22e (coil conductor layer 18e).

The lead conductor layer 24a is disposed in the insulator layer 16b so as to penetrate the insulator layer 16b in the vertical direction. As shown in FIG. 2 and FIG. 4B, the lead conductor layer 24a is connected to the portion 20a of the coil conductor layer 18a and is exposed at the left side of the insulator layer 16b to outside the multilayer body 12.

The lead conductor layer 24b is disposed in the insulator layer 16g so as to penetrate the insulator layer 16g in the vertical direction. As shown in FIG. 2 and FIG. 4B, the lead conductor layer 24b is connected to the portion 22f of the coil conductor layer 18f and is exposed at the right side of the insulator layer 16g to outside the multilayer body 12.

The above-described coil conductor layers 18a to 18f and the lead conductor layers 24a and 24b are produced from a conductor containing, for example, silver or copper as a primary component.

As shown in FIG. 1 and FIG. 4B, outer electrode 14a covers the entire left surface of the multilayer body 12 and, in addition, extends on the upper surface, the lower surface, the front surface, and the rear surface of the multilayer body 12. Consequently, the outer electrode 14a is connected to the lead conductor layer 24a. As shown in FIG. 1 and FIG. 4B, outer electrode 14b covers the entire right surface of the multilayer body 12 and, in addition, extends on the upper surface, the lower surface, the front surface, and the rear surface of the multilayer body 12. Consequently, the outer electrode 14b is connected to the lead conductor layer 24b. The outer electrodes 14a and 14b are formed by applying Ni plating and Sn plating to an underlying electrode formed from a material containing, for example, silver as a primary component.

Manufacturing Method

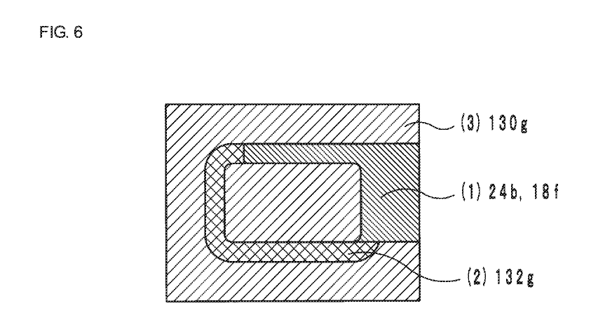

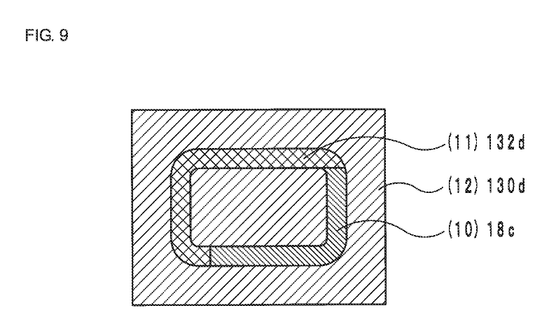

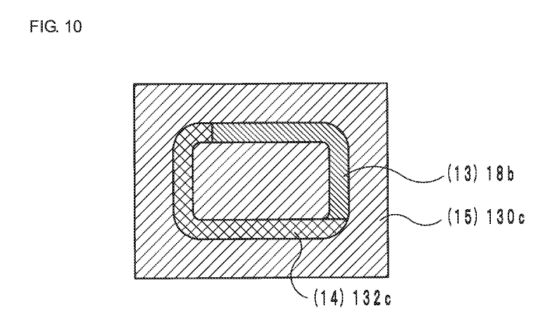

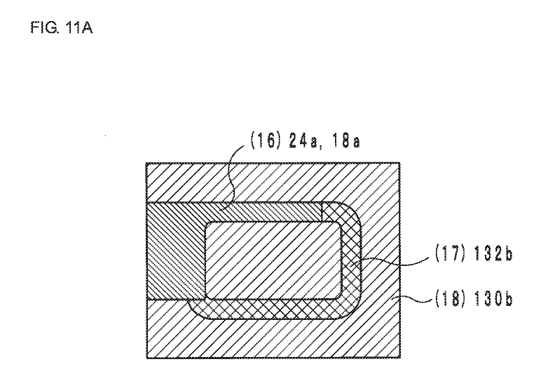

A method for manufacturing the electronic component 10 will be described below with reference to FIG. 5 to FIG. 11A. FIG. 5 to FIG. 11A are plan views showing the manner at the time of production of the electronic component 10. In this regard, FIG. 5 to FIG. 11A show the manner at the time of production of one electronic component 10. However, at the time of the actual production, a mother multilayer body is produced and, thereafter, the mother multilayer body is cut into a plurality of multilayer bodies 12.

A first ceramic slurry serving as the raw material for the insulator layers 16a and 16h and the magnetic portions 30b to 30g is produced. Each of the materials is weighed and the raw material composed of about 48.0 percent by mole of ferric oxide (Fe₂O₃), about 20.0 percent by mole of zinc oxide (ZnO), about 23.0 percent by mole of nickel oxide (NiO), and about 9.0 percent by mole of copper oxide (CuO) is put into a ball mill so as to perform wet mixing. The resulting mixture is dried and is pulverized. The resulting powder is calcined at about 750° C. for about 1 hour. The resulting calcined powder is wet-pulverized in a ball mill, and drying and disintegration are performed so as to obtain a ferrite ceramic powder.

A binder (vinyl acetate, water-soluble acryl, or the like), a plasticizer, a wetting agent, and a dispersing agent are added to the resulting ferrite ceramic powder, mixing is performed in a ball mill and, thereafter, degassing is performed under reduced pressure. In this manner, the first ceramic slurry serving as the raw material for the insulator layers 16a and 16h and the magnetic portions 30b to 30g is produced.

A second ceramic slurry serving as the raw material for the nonmagnetic portions 32b to 32g is produced. Each of the materials is weighed and the raw material composed of about 48.0 percent by mole of ferric oxide (Fe₂O₃), about 43.0 percent by mole of zinc oxide (ZnO), and about 9.0 percent by mole of copper oxide (CuO) is put into a ball mill so as to perform wet mixing. The resulting mixture is dried and is pulverized. The resulting powder is calcined at about 750° C. for about 1 hour. The resulting calcined powder is wet-pulverized in a ball mill, and drying and disintegration are performed so as to obtain a ferrite ceramic powder.

A binder (vinyl acetate, water-soluble acryl, or the like), a plasticizer, a wetting agent, and a dispersing agent are added to the resulting ferrite ceramic powder, mixing is performed in a ball mill and, thereafter, degassing is performed under reduced pressure. In this manner, the second ceramic slurry serving as the raw material for the nonmagnetic portions 32b to 32g is produced.

As shown in FIG. 5, a ceramic green layer 116h serving as the insulator layer 16h is formed by printing of the first ceramic slurry.

As shown in FIG. 6 (1), the ceramic green layers 116h are coated with an electrically conductive paste containing Ag, Pd, Cu, Au, or an alloy thereof as a primary component by a screen printing method, a photolithography method, or the like so as to form a coil conductor layer 18f and the lead conductor layer 24b.

As shown in FIG. 6 (2), the ceramic green layer 116h is coated with the second ceramic slurry by the screen printing method so as to form the ceramic green portion 132g serving as the nonmagnetic portion 32g.

As shown in FIG. 6 (3), the ceramic green layer 116h is coated with the first ceramic slurry by the screen printing method so as to form the ceramic green portion 130g serving as the magnetic portion 30g.

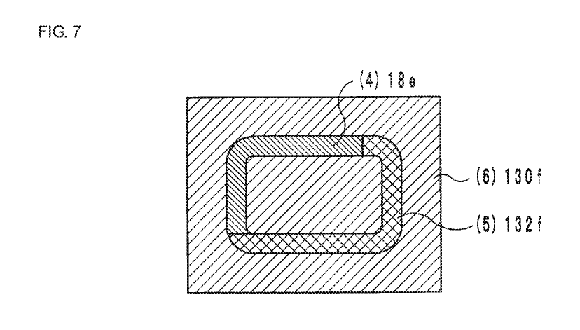

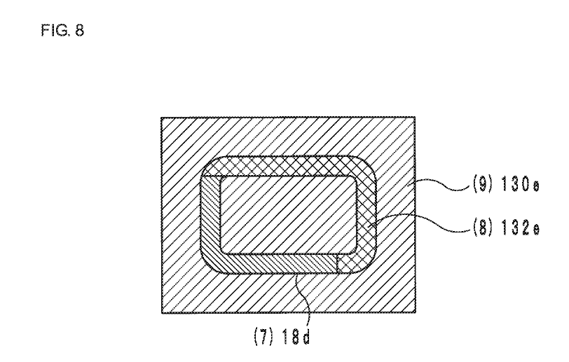

Subsequently, the steps shown in FIG. 6 (1), (2) and (3) are repeated and, thereby, ceramic green portions 130b to 130f and 132b to 132f, coil conductor layers 18a to 18e, and the lead conductor layer 24a are formed, as shown in FIG. 7 to FIG. 11A.

A ceramic green layer 116a (not shown in the drawing) serving as the insulator layer 16a is formed by applying the first ceramic slurry by the screen printing method so as to cover the ceramic green portions 130b and 132b, coil conductor layer 18a, and the lead conductor layer 24a. A mother multilayer body is formed through the above-described steps. The mother multilayer body is subjected to regular pressure bonding by isostatic press or the like. The regular pressure bonding is performed at about 45° C. and about 1.0 t/cm², for example.

The mother multilayer body is cut into a multilayer body 12 having a predetermined size (for example, about 3.2 mm×2.5 mm×0.8 mm). In this manner, an unfired multilayer body 12 is produced. The unfired multilayer body 12 is subjected to a debinder treatment and firing. The debinder treatment is performed in a low-oxygen environment at about 500° C. for about 2 hours, for example. The firing is performed in the air at about 890° C. for about 2.5 hours, for example.

A fired multilayer body 12 is produced by the above-described steps. The multilayer body 12 is subjected to barrel finishing so as to be chamfered. Then, an electrically conductive paste containing silver as a primary component is applied by a dipping method or the like and baking is performed so as to form underlying electrodes serving as the outer electrodes 14A and 14b. The underlying electrodes are dried at about 100° C. for about 10 minutes, and the underlying electrodes are baked at about 780° C. for 2.5 hours.

Finally, Ni plating/Sn plating is applied to the surface of the underlying electrodes so as to form the outer electrodes 14a and 14b. The electronic component 10 as shown in FIG. 1 is completed through the above-described steps.

Advantage

The electronic component 10 according to the present embodiment can suppress an occurrence of short-circuit in the coil L. FIG. 11B is a diagram showing the positional relationship between coil conductor layers 318a to 318f in an electronic component 300 according to a comparative example.

The electronic component 300 according to the comparative example has the same structure as the structure of the multilayer electronic component described in Japanese Unexamined Patent Application Publication No. 2010-183007. In the electronic component 300, both ends of each of the coil conductor layers 318a to 318f are disposed at the respective corners C1 to C4, when viewed from above. Therefore, at the corner C1, the end portion of the coil conductor layer 318a and the end portion of the coil conductor layer 318c are opposite to each other with one insulator layer interposed therebetween. At the corner C2, the end portion of the coil conductor layer 318b and the end portion of the coil conductor layer 318d are opposite to each other with one insulator layer interposed therebetween. At the corner C3, the end portion of the coil conductor layer 318c and the end portion of the coil conductor layer 318e are opposite to each other with one insulator layer interposed therebetween. At the corner C4, the end portion of the coil conductor layer 318d and the end portion of the coil conductor layer 318f are opposite to each other with one insulator layer interposed therebetween. Consequently, short-circuit may occur in the coil at the corners C1 to C4.

On the other hand, in the electronic component 10, each end portion of the coil conductor layers 18a to 18f is not disposed at the corners C1 to C4, when viewed from above. Consequently, at the corner C1, coil conductor layers are not opposite to each other. At the corner C2, the coil conductor layer 18a and the coil conductor layer 18e are opposite to each other with three insulator layers interposed therebetween. At the corner C3, the coil conductor layer 18b and the coil conductor layer 18f are opposite to each other with three insulator layers interposed therebetween. At the corner C4, coil conductor layers are not opposite to each other. In this manner, in the electronic component 10, the distances between the coil conductor layers at the corners C1 to C4 are larger than the distances in the electronic component 300. Consequently, an occurrence of short-circuit at the corners C1 to C4 in the coil L is suppressed.

In the electronic component 10, an increase in the direct current resistance value of the coil L can be suppressed. Specifically, each end portion of the coil conductor layers 18a to 18f is not disposed at the corners C1 to C4, when viewed from above. Consequently, at the corners C1 to C4, the thicknesses of the coil L in the vertical direction decrease and the direct current resistance values may increase. However, the line widths of the coil conductor layers 18a to 18f at the corners C1 to C4 of the track R are larger than the line widths of the coil conductor layers 18a to 18f at portions excluding the corners C1 to C4. Consequently, the amount of increase in the direct current resistance value of the coil L is reduced.

In the electronic component 10, an occurrence of short-circuit in the coil L can be suppressed and, in addition, an occurrence of break in the coil L can be suppressed for the reasons as described below. In the electronic component 300 according to the comparative example, short-circuit may occur in the coil at the corners C1 to C4. In order to suppress an occurrence of short-circuit in the coil in such an electronic component 300, for example, none of the end portions of the coil conductor layers 18a to 18f has to be disposed at the corners C1 to C4, when viewed from above.

However, even when none of the end portions of the coil conductor layers 18a to 18f is disposed at the corners C1 to C4, if the coil conductor layers 18a to 18f are in contact with the outer edge portions of the corners C1 to C4, the coil conductor layers 18a to 18f are brought close to each other at the outer edge portions of the corners C1 to C4. In order to solve such a problem, it is considered that none of the end portions of the coil conductor layers 18a to 18f is brought into contact with the outer edge portions of the corners C1 to C4. However, in this case, the portions 20a to 20f and 22a to 22f become short. In particular, if the portions 22b, 20c, 22d, and 20e, which overlap the short sides of the track R, become short, the contact area between the coil conductor layer 18b and the coil conductor layer 18c and the contact area between the coil conductor layer 18d and the coil conductor layer 18e decrease. As a result, a break may occur between the coil conductor layer 18b and the coil conductor layer 18c or between the coil conductor layer 18d and the coil conductor layer 18e.

Then, in the electronic component 10, the coil conductor layer 18a is in contact with the corner C1 and is not in contact with the corner C3, when viewed from above. The coil conductor layer 18b is in contact with the corner C4 and is not in contact with the corner C2, when viewed from above. The coil conductor layer 18c is in contact with the corner C3 and is not in contact with the corner C1, when viewed from above. The coil conductor layer 18d is in contact with the corner C2 and is not in contact with the corner C4, when viewed from above. The coil conductor layer 18e is in contact with the corner C1 and is not in contact with the corner C3, when viewed from above. The coil conductor layer 18f is in contact with the corner C4 and is not in contact with the corner C2, when viewed from above. Consequently, the portions 22a, 20b, 22c, 20d, 22e, and 20f, which overlap the long sides of the track R, become short, and the portions 22b, 20c, 22d, and 20e, which overlap the short sides of the track R, do not become short. However, the portions 22a, 20b, 22c, 20d, 22e, and 20f have sufficient lengths and, therefore, the possibility of an occurrence of a break between the coil conductor layer 18a and the coil conductor layer 18b, between the coil conductor layer 18c and the coil conductor layer 18d, or between the coil conductor layer 18e and the coil conductor layer 18f is low. As described above, in the electronic component 10, an occurrence of short-circuit in the coil L can be suppressed and, in addition, an occurrence of break in the coil L can be suppressed. However, this does not prevent the coil conductor layers 18a to 18f from coming into contact with the corners C1 to C4.

In the electronic component 10, the track R is formed by combining the nonmagnetic portions 32b to 32g and the coil conductor layers 18a to 18f with each other. Consequently, regarding the track R, the coil conductor layers 18a to 18f and the nonmagnetic portions 32b to 32g are arranged alternately in the vertical direction, as shown in FIG. 4B. Consequently, reduction of the inductance value of the coil L is suppressed in a region where the current value is small.

In the electronic component 10, the nonmagnetic portions 32 are disposed at the locations overlapping the track R but may extend off the track R. That is, the nonmagnetic portions 32 may be disposed inside and/or outside the coil L, when viewed from above. Consequently, reduction of the inductance value of the coil L is suppressed in a region where the current value is small.

### First Modified Example

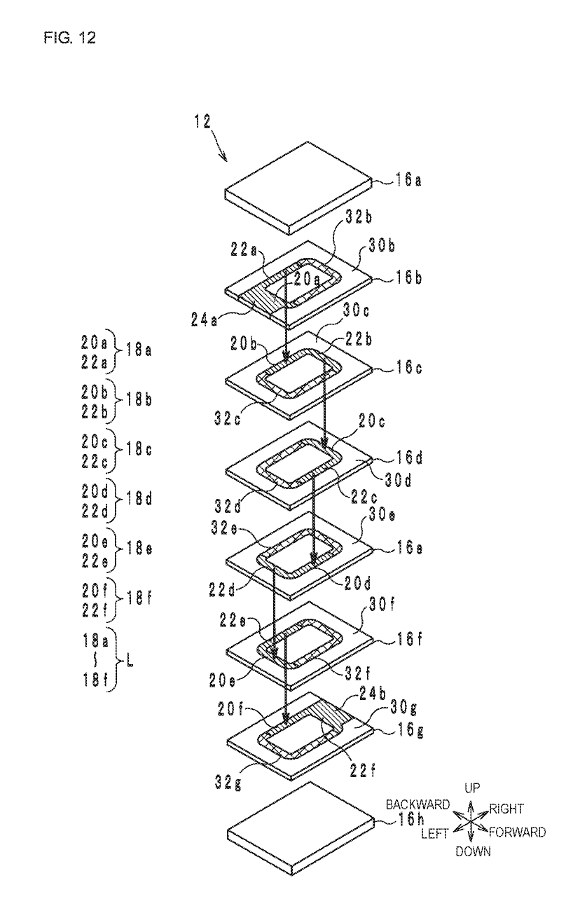

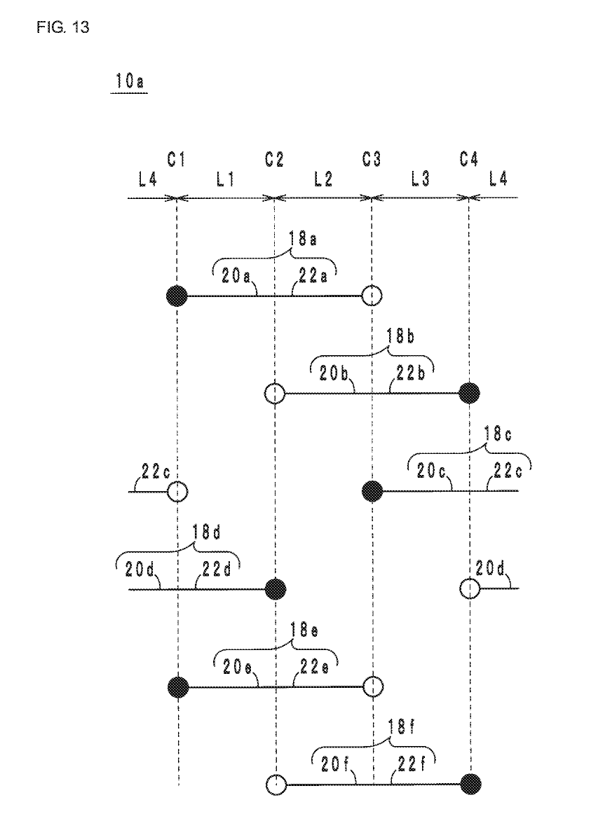

An electronic component according to a first modified example will be described below with reference to the drawings. FIG. 12 is an exploded perspective view of a multilayer body 12 of an electronic component 10a according to the first modified example. FIG. 13 is a diagram showing the positional relationship between the coil conductor layers 18a to 18f in the electronic component 10a according to the first modified example. An outside perspective view of the electronic component 10a is referred to FIG. 1.

The electronic component 10a is different from the electronic component 10 in the shapes of the coil conductor layers 18a to 18f. The electronic component 10a will be described below centering on the different points.

In the electronic component 10a, as shown in FIG. 12 and FIG. 13, the coil conductor layers 18a and 18e are disposed at the corner C1 and are not disposed at the corner C3, when viewed from above. The coil conductor layers 18b and 18f are disposed at the corner C4 and are not disposed at the corner C2, when viewed from above. The coil conductor layer 18c is disposed at the corner C3 and is not disposed at the corner C1, when viewed from above. The coil conductor layer 18d is disposed at the corner C2 and is not disposed at the corner C4, when viewed from above.

In the electronic component 10a, an occurrence of short-circuit in the coil L can be suppressed as in the electronic component 10. Specifically, at the corner C1, the coil conductor layer 18a and the coil conductor layer 18d are opposite to each other with two insulator layers interposed therebetween. At the corner C2, the coil conductor layer 18a and the coil conductor layer 18d are opposite to each other with two insulator layers interposed therebetween. At the corner C3, the coil conductor layer 18c and the coil conductor layer 18f are opposite to each other with two insulator layers interposed therebetween. At the corner C4, the coil conductor layer 18c and the coil conductor layer 18f are opposite to each other with two insulator layers interposed therebetween. As described above, in the electronic component 10a, the distances between the coil conductor layers at the corners C1 to C4 are larger than the distances in the electronic component 300. Consequently, an occurrence of short-circuit at the corners C1 to C4 in the coil L can be suppressed.

In the electronic component 10a, an occurrence of short-circuit in the coil L can be suppressed and, in addition, an occurrence of break in the coil L can be suppressed for the same reasons as for the electronic component 10.

### Second Modified Example to Fifth Modified Example

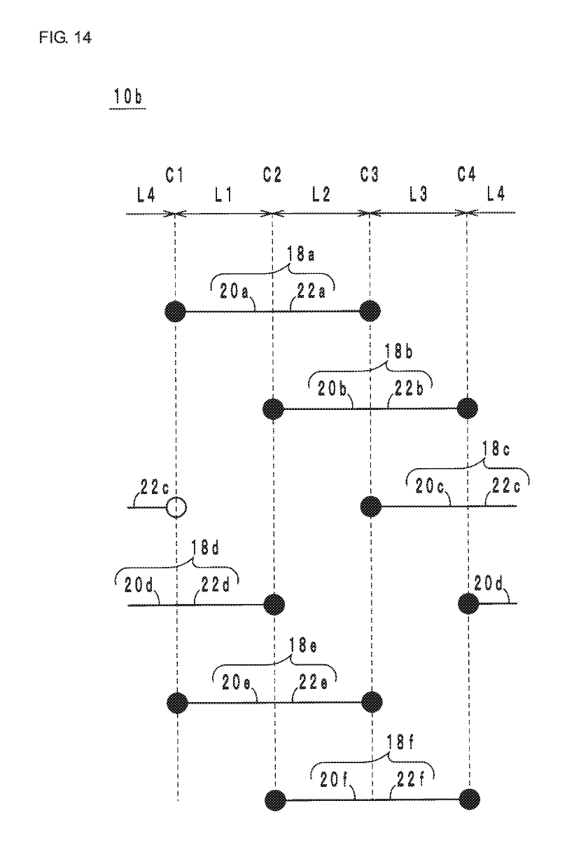

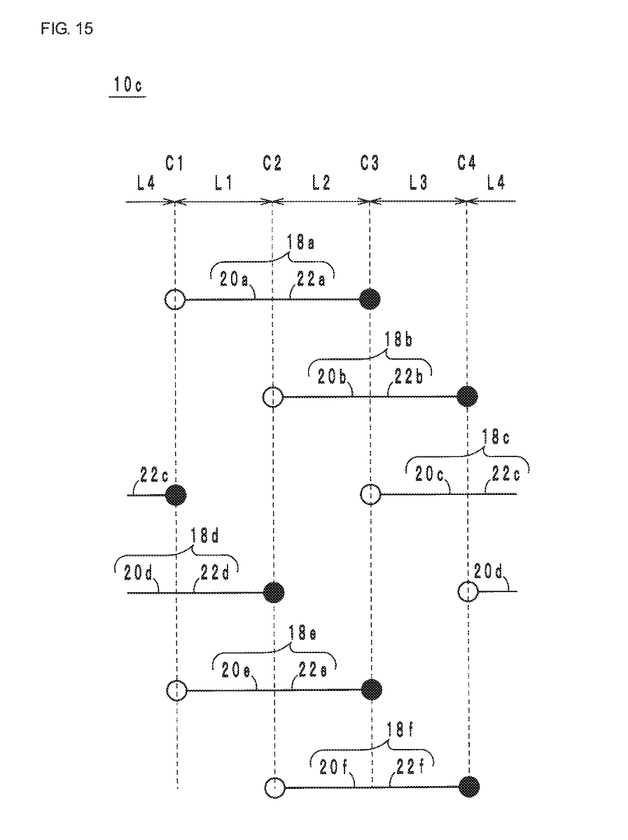

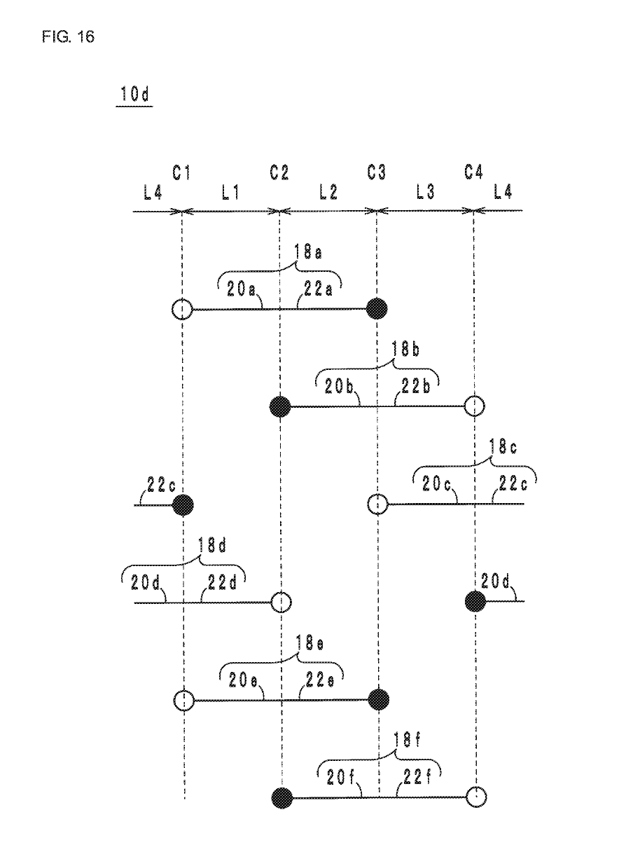

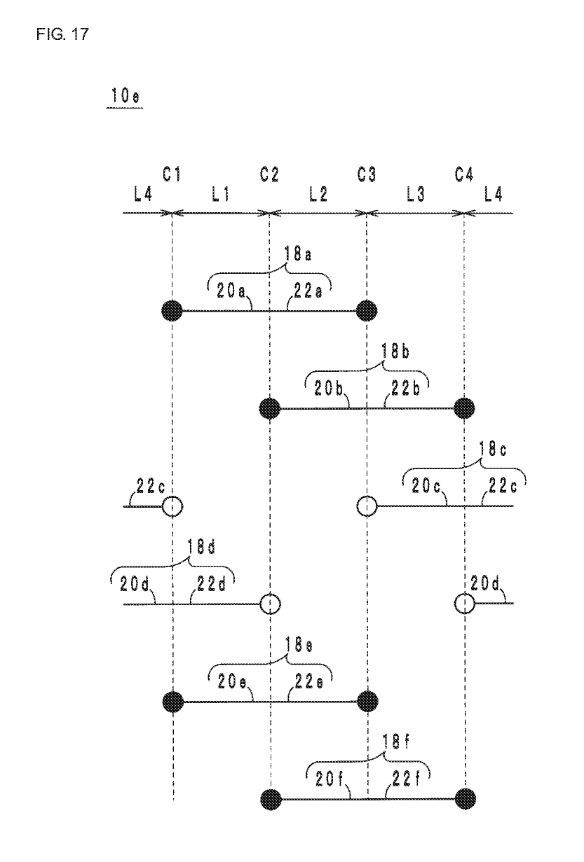

Electronic components according to a second modified example to a fifth modified example will be described below with reference to the drawings. FIG. 14 is a diagram showing the positional relationship between the coil conductor layers 18a to 18f in an electronic component 10b according to a second modified example. FIG. 15 is a diagram showing the positional relationship between the coil conductor layers 18a to 18f in an electronic component 10c according to a third modified example. FIG. 16 is a diagram showing the positional relationship between the coil conductor layers 18a to 18f in an electronic component 10d according to a fourth modified example. FIG. 17 is a diagram showing the positional relationship between the coil conductor layers 18a to 18f in an electronic component 10e according to a fifth modified example. Outside perspective views of the electronic components 10b to 10e are referred to FIG. 1.

The electronic component 10b is different from the electronic component 10 in the shapes of the coil conductor layers 18a to 18f. The electronic component 10b will be described below centering on the different points.

In the electronic component 10b, as shown in FIG. 14, the coil conductor layers 18a and 18e are disposed at the corners C1 and C3, when viewed from above. The coil conductor layers 18b and 18f are disposed at the corner C2 and C4, when viewed from above. The coil conductor layer 18c is disposed at the corner C3 and is not disposed at the corner C1, when viewed from above. The coil conductor layer 18d is disposed at the corners C2 and C4, when viewed from above.

In the electronic component 10a, an occurrence of short-circuit in the coil L can be suppressed as in the electronic component 10. Specifically, at the corner C1, the coil conductor layer 18a and the coil conductor layer 18d are opposite to each other with two insulator layers interposed therebetween. Consequently, at the corner C1, it is avoided that the coil conductor layer 18a and the coil conductor layer 18c are opposite to each other with one insulator layer interposed therebetween, and an occurrence of short-circuit between the coil conductor layer 18a and the coil conductor layer 18c is suppressed.

As described above, it is not necessary that an occurrence of short-circuit is suppressed at all the corners C1 to C4 of the coil L. An occurrence of short-circuit in the coil L at only one corner among the corners C1 to C4 has to be suppressed. The condition, under which an occurrence of short-circuit in the coil L at the corner C1 can be suppressed, is denoted as a condition 1, the condition, under which an occurrence of short-circuit in the coil L at the corner C2 can be suppressed, is denoted as a condition 2, the condition, under which an occurrence of short-circuit in the coil L at the corner C3 can be suppressed, is denoted as a condition 3, and the condition, under which an occurrence of short-circuit in the coil L at the corner C4 can be suppressed, is denoted as a condition 4.

Condition 1

In order to suppress an occurrence of short-circuit between the coil conductor layer 18a (an example of the first coil conductor layer) and the coil conductor layer 18c (an example of the third coil conductor layer), that is, at the corner C1, it is necessary that at least one of the coil conductor layer 18a and the coil conductor layer 18c be not disposed at the corner C1, when viewed from above.

Condition 2

In order to suppress an occurrence of short-circuit between the coil conductor layer 18b (an example of the first coil conductor layer or the second coil conductor layer) and the coil conductor layer 18d (an example of the third coil conductor layer or the fourth coil conductor layer), that is, at the corner C2, it is necessary that at least one of the coil conductor layer 18b and the coil conductor layer 18d be not disposed at the corner C2, when viewed from above.

Condition 3

In order to suppress an occurrence of short-circuit between the coil conductor layer 18c (an example of the first coil conductor layer or the third coil conductor layer) and the coil conductor layer 18e (an example of the third coil conductor layer or the fifth coil conductor layer), that is, at the corner C3, it is necessary that at least one of the coil conductor layer 18c and the coil conductor layer 18e be not disposed at the corner C3, when viewed from above.

Condition 4

In order to suppress an occurrence of short-circuit between the coil conductor layer 18d (an example of the first coil conductor layer or the fourth coil conductor layer) and the coil conductor layer 18f (an example of the third coil conductor layer or the sixth coil conductor layer), that is, at the corner C4, it is necessary that at least one of the coil conductor layer 18d and the coil conductor layer 18f be not disposed at the corner C4, when viewed from above.

Any one of the above-described condition 1 to condition 4 has to be satisfied. Examples of electronic components satisfying all of the condition 1 to the condition 4 include the electronic components 10c to 10e according to the third to fifth modified examples (refer to FIG. 15 to FIG. 17). In the electronic components 10c to 10e, an occurrence of short-circuit in the coil L is suppressed at all the corners C1 to C4.

### Sixth Modified Example

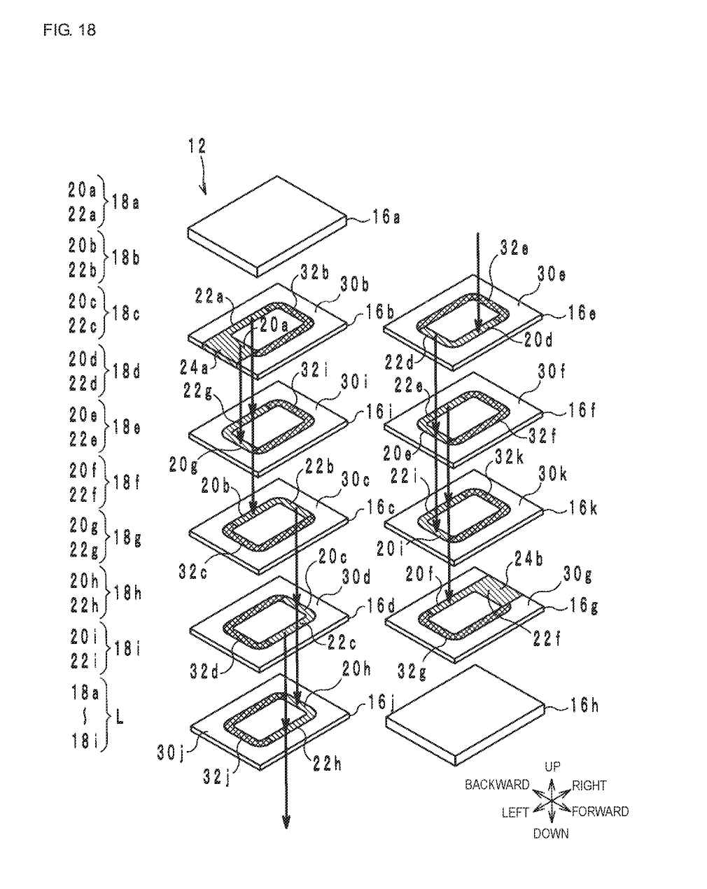

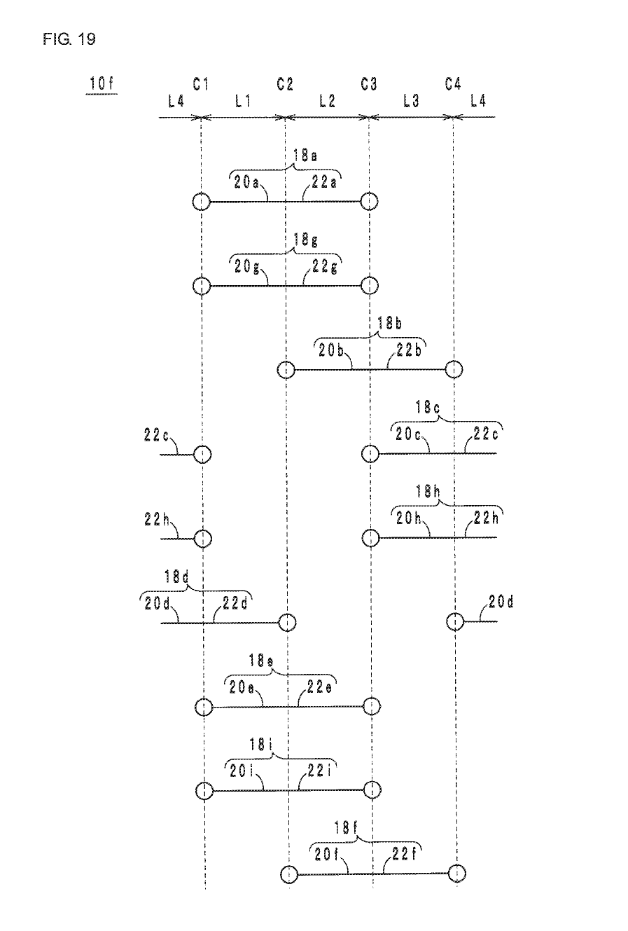

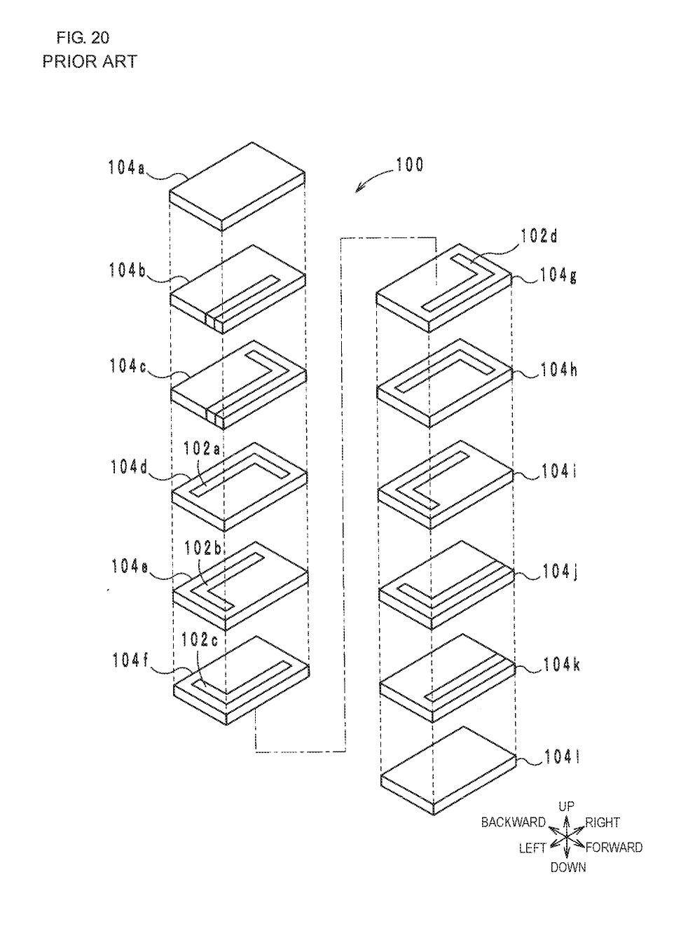

An electronic component according to a sixth modified example will be described below with reference to the drawings. FIG. 18 is an exploded perspective view of a multilayer body 12 of an electronic component 10f according to a sixth modified example. FIG. 19 is a diagram showing the positional relationship between the coil conductor layers 18a to 18i in the electronic component 10f according to the sixth modified example. An outside perspective view of the electronic component 10f is referred to FIG. 1.

The electronic component 10f is different from the electronic component 10 in that insulator layers 16i to 16k and coil conductor layers 18g to 18i are further included. The electronic component 10f will be described below centering on the different points.

The insulator layers 16a to 16h of the electronic component 10f are the same as the insulator layers 16a to 16h of the electronic component 10 and, therefore, explanations thereof will not be provided.

The insulator layer 16i is stacked between the insulator layer 16b and the insulator layer 16c. The structure of the insulator layer 16i is the same as the structure of the insulator layer 16b. However, in the insulator layer 16i, the lead conductor layer 24a is not disposed and a magnetic portion 30i is disposed in the portion corresponding to the lead conductor layer 24a. The insulator layer 16j is stacked between the insulator layer 16d and the insulator layer 16e. The structure of the insulator layer 16j is the same as the structure of the insulator layer 16d. The insulator layer 16k is stacked between the insulator layer 16f and the insulator layer 16g. The structure of the insulator layer 16k is the same as the structure of the insulator layer 16f.

The coil L includes the coil conductor layers 18a, 18g, 18b, 18c, 18h, 18d, 18e, 18i, and 18f arranged in that order from top to bottom. The coil conductor layers 18a to 18f of the electronic component 10f are the same as the coil conductor layers 18a to 18f of the electronic component 10 and, therefore, explanations thereof will not be provided.

As shown in FIG. 18 and FIG. 19, the coil conductor layer 18g (an example of the second coil conductor layer) lies astride the sides L1 and L2 and has the shape of substantially the letter L, when viewed from above. The coil conductor layer 18g is disposed in the insulator layer 16i so as to penetrate the insulator layer 16i in the vertical direction. That is, the thickness of the coil conductor layer 18g is substantially equal to the thickness of the insulator layer 16i. Consequently, the coil conductor layer 18g having the shape of substantially the letter L is exposed when the insulator layer 16i is viewed from above and when the insulator layer 16i is viewed from below.

The coil conductor layer 18g is disposed in a portion excluding the corner C1 of the side L1 and a portion excluding the vicinity of the right end of the side L2. Therefore, as shown in FIG. 18 and FIG. 19, the coil conductor layer 18g is not disposed at the corners C1 and C3. Hereafter in the coil conductor layer 18g, a portion overlapping the side L1 is referred to as a portion 20g and in the coil conductor layer 18g, a portion overlapping the side L2 is referred to as a portion 22g. As shown in FIG. 18, the portion 22g (that is, the coil conductor layer 18g) is disposed in the portion excluding the vicinity of the right end of the side L2 and, therefore, is not in contact with the corner C3. That is, a nonmagnetic portion 32i is present between the right end of the portion 22g and the corner C3. The coil conductor layer 18g constitutes the track R by being combined with the nonmagnetic portion 32i, when viewed from above. The portions 20g and 22g of the coil conductor layer 18g are connected to the portions 20a and 22a (coil conductor layer 18a). In addition, the portion 22g of the coil conductor layer 18g is connected to the portion 20b (coil conductor layer 18b (an example of the third coil conductor layer)).

The portion 20c of the coil conductor layer 18c (an example of the fourth coil conductor layer) is connected to the coil conductor layer 18b.

As shown in FIG. 18 and FIG. 19, the coil conductor layer 18h (an example of the fifth coil conductor layer) lies astride the sides L3 and L4 and has the shape of substantially the letter L, when viewed from above. The coil conductor layer 18h is disposed in the insulator layer 16j so as to penetrate the insulator layer 16j in the vertical direction. That is, the thickness of the coil conductor layer 18h is substantially equal to the thickness of the insulator layer 16j. Consequently, the coil conductor layer 18h having the shape of substantially the letter L is exposed when the insulator layer 16j is viewed from above and when the insulator layer 16j is viewed from below.

The coil conductor layer 18h is disposed in a portion excluding the corner C3 of the side L3 and a portion excluding the vicinity of the left end of the side L4. Therefore, as shown in FIG. 18 and FIG. 19, the coil conductor layer 18h is not disposed at the corners C1 and C3. Hereafter in the coil conductor layer 18h, a portion overlapping the side L3 is referred to as a portion 20h and in the coil conductor layer 18h, a portion overlapping the side L4 is referred to as a portion 22h. As shown in FIG. 18, the portion 22h (that is, the coil conductor layer 18h) is disposed in the portion excluding the vicinity of the left end of the side L4 and, therefore, is not in contact with the corner C1. That is, a nonmagnetic portion 32j is present between the left end of the portion 22h and the corner C1. The coil conductor layer 18h constitutes the track R by being combined with the nonmagnetic portion 32j, when viewed from above. The portions 20h and 22h of the coil conductor layer 18h are connected to the portions 20c and 22c (coil conductor layer 18c). In addition, the portion 22h of the coil conductor layer 18h is connected to the portion 20d (coil conductor layer 18d).

The portion 22d of the coil conductor layer 18d is connected to the coil conductor layer 18e.

As shown in FIG. 18 and FIG. 19, the coil conductor layer 18i lies astride the sides L1 and L2 and has the shape of substantially the letter L, when viewed from above. The coil conductor layer 18i is disposed in the insulator layer 16k so as to penetrate the insulator layer 16k in the vertical direction. That is, the thickness of the coil conductor layer 18i is substantially equal to the thickness of the insulator layer 16k. Consequently, the coil conductor layer 18i having the shape of substantially the letter L is exposed when the insulator layer 16k is viewed from above and when the insulator layer 16k is viewed from below.

The coil conductor layer 18i is disposed in a portion excluding the corner C1 of the side L1 and a portion excluding the vicinity of the right end of the side L2. Therefore, as shown in FIG. 18 and FIG. 19, the coil conductor layer 18i is not disposed at the corners C1 and C3. Hereafter in the coil conductor layer 18i, a portion overlapping the side L1 is referred to as a portion 20i and in the coil conductor layer 18i, a portion overlapping the side L2 is referred to as a portion 22i. As shown in FIG. 18, the portion 22i (that is, the coil conductor layer 18i) is disposed in the portion excluding the vicinity of the right end of the side L2 and, therefore, is not in contact with the corner C3. That is, a nonmagnetic portion 32k is present between the right end of the portion 22i and the corner C3. The coil conductor layer 18i constitutes the track R by being combined with the nonmagnetic portion 32k, when viewed from above. The portions 20i and 22i of the coil conductor layer 18i are connected to the portions 20e and 22e (coil conductor layer 18e). In addition, the portion 22i of the coil conductor layer 18i is connected to the portion 20f (coil conductor layer 18f).

The above-described electronic component 10f can have the same operations and advantages as those of the electronic component 10.

In the electronic component 10f, the coil conductor layers 18a and 18g having the same shape are connected to each other. The coil conductor layers 18c and 18h having the same shape are connected to each other. The coil conductor layers 18e and 18i having the same shape are connected to each other. Consequently, the direct current resistance value of the coil L is reduced.

### Other Embodiments

The electronic component according to embodiments of the present disclosure is not limited to the electronic components 10 and 10a to 10f and can be modified within the scope of the gist thereof.

The configurations of the electronic components 10 and 10a to 10f may be combined appropriately.

In the electronic components 10 and 10a to 10f, the entirety of the multilayer body 12 may be produced from magnetic materials.

In the electronic component 10, at least three coil conductor layers have to be disposed. This is because, for example, in the case where three coil conductor layers 18a to 18c are disposed, the coil conductor layer 18a and the coil conductor layer 18c can be opposed to each other with one insulator layer interposed therebetween at the corner C1, as shown in FIG. 4A.

As described above, the present disclosure is useful for electronic components and, in particular, is excellent in the point that an occurrence of short-circuit in the coil can be suppressed.

While preferred embodiments of the disclosure have been described above, it is to be understood that variations and modifications will be apparent to those skilled in the art without departing from the scope and spirit of the disclosure. The scope of the disclosure, therefore, is to be determined solely by the following claims.

What is claimed is:

1. An electronic component comprising:
a multilayer body having a configuration, in which a plurality of insulator layers are stacked in the stacking direction; and
a coil which is disposed in the multilayer body and which includes a first coil conductor layer, a second coil conductor layer, and a third coil conductor layer arranged in that order from one side of the stacking direction toward the other side,
wherein a first side, a second side, a third side, and a fourth side are connected in that order in a predetermined direction so as to demarcate a tetragonal track, when viewed from the stacking direction,
the first coil conductor layer lies astride the first side and the second side,
the second coil conductor layer lies astride the second side and the third side and is connected to the first coil conductor layer on the second side,
the third coil conductor layer lies astride the third side and the fourth side and is connected to the second coil conductor layer on the third side, and
at least one of the first coil conductor layer and the third coil conductor layer is not disposed at a first corner formed by the first side and the fourth side, when viewed from the stacking direction.

2. The electronic component according to claim 1,
wherein the first coil conductor layer and the third coil conductor layer are not disposed at the first corner, when viewed from the stacking direction.

3. The electronic component according to claim 1,
wherein the coil further includes a fourth coil conductor layer,
the first coil conductor layer to the fourth coil conductor layer are arranged in that order from one side of the stacking direction toward the other side,
the fourth coil conductor layer lies astride the fourth side and the first side and is connected to the third coil conductor layer on the fourth side, and
at least one of the second coil conductor layer and the fourth coil conductor layer is not disposed at a second corner formed by the first side and the second side, when viewed from the stacking direction.

4. The electronic component according to claim 3,
wherein the coil further includes a fifth coil conductor layer,
the first coil conductor layer to the fifth coil conductor layer are arranged in that order from one side of the stacking direction toward the other side,
the fifth coil conductor layer lies astride the first side and the second side and is connected to the fourth coil conductor layer on the first side, and
at least one of the third coil conductor layer and the fifth coil conductor layer is not disposed at a third corner formed by the second side and the third side, when viewed from the stacking direction.

5. The electronic component according to claim 4,
wherein the coil further includes a sixth coil conductor layer,
the first coil conductor layer to the sixth coil conductor layer are arranged in that order from one side of the stacking direction toward the other side,
the sixth coil conductor layer lies astride the second side and the third side and is connected to the fifth coil conductor layer on the second side, and
at least one of the fourth coil conductor layer and the sixth coil conductor layer is not disposed at a fourth corner formed by the third side and the fourth side, when viewed from the stacking direction.

6. The electronic component according to claim 1,
wherein the track has a rectangular shape,
the first side and the third side are short sides and the second side and the fourth side are long sides, and
the first coil conductor layer is not in contact with the third corner formed by the second side and the third side.

7. An electronic component comprising:
a multilayer body having a configuration, in which a plurality of insulator layers are stacked in the stacking direction; and
a coil which is disposed in the multilayer body and which includes a first coil conductor layer, a second coil conductor layer, a third coil conductor layer, and a fourth coil conductor layer arranged in that order from one side of the stacking direction toward the other side,
wherein a first side, a second side, a third side, and a fourth side are connected in that order in a predetermined direction so as to demarcate a tetragonal track, when viewed from the stacking direction,
the first coil conductor layer and the second coil conductor layer lie astride the first side and the second side and are connected to each other on the first side and the second side,
the third coil conductor layer lies astride the second side and the third side and is connected to the second coil conductor layer on the second side,
the fourth coil conductor layer lies astride the third side and the fourth side and is connected to the third coil conductor layer on the third side, and
at least one of the second coil conductor layer and the fourth coil conductor layer is not disposed at a first corner formed by the first side and the fourth side, when viewed from the stacking direction.

8. The electronic component according to claim 7,
wherein the coil further includes a fifth coil conductor layer,
the first coil conductor layer to the fifth coil conductor layer are arranged in that order from one side of the stacking direction toward the other side, and
the fifth coil conductor layer lies astride the third side and the fourth side and is connected to the fourth coil conductor layer on the third side and the fourth side.
